(19) United States
(12) Patent Application Publication
(10) Pub. No.: US 2002/0091609 A1
(43) Pub. Date: Jul. 11, 2002

(54) System and method for providing data analysis and interpretation

(76) Inventor: Michael J. Markowski, Tallahassee, FL (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/010,566

(22) Filed: Dec. 7, 2001

Related U.S. Application Data
(60) Provisional application No. 60/254,203, filed on Dec. 7, 2000.

(51) Int. Cl. G06F 17/60

(52) U.S. Cl. 705/36

(57) ABSTRACT

A system, product and method for assisting an individual to analyze a domain-specific parameter, such as a company's security. In a client-server computing environment, the server computer executes computer program instructions to (1) receive from the client computer an identification of a parameter to be analyzed, (2) obtain from a data source a current value for the parameter, and (3) provide to the user computer an evaluation of the current value and an explanation of a possible significance of that evaluation.

Priority is claimed under 35 USC 119(e) from provisional application serial No. 60/254,203, filed on Dec. 7, 2000.

### FIELD OF THE INVENTION

This invention relates to the field of data presentation and analysis and, more particularly, to a method and system for facilitating the presentation and understanding of stock market and company performance data by an individual.

### BACKGROUND OF THE INVENTION

The analysis of securities which are publicly traded on one or more of the world's stock markets presents a substantial challenge to a user. In order to achieve a high level of understanding of the data, a user must relate that data to comparable data for other stocks, look at the data historically, digest a number of calculated parameters, and so forth. There is no single way or sequence in which to view, compare or analyze the information. No clear starting point and no clear ending point. Also, there is no commonly accepted path or sequence through the information. Many investors and others interested in the stock markets may thus fail to consider important information, not know what information to consider or how to consider it, and lack the knowledge and resources to facilitate a comparison of one stock with another. At times, important information even may be overlooked. A challenge, therefore, is how individuals may be helped through this maze of information and issues when they have diverse expertise and knowledge, are interested in differently emphasizing aspects of stock analysis, and wish to begin, or in any event do begin, at different points on the analytical map. Heretofore, one has been able to subscribe to many publications which provide the raw data, such as charts of trading volume, stock price over time, sector performance, and so forth. But there has been no integrated tool that provides a situational analysis of a stock based on real-time data. For example, there has not been a tool which analyzes a stock's price trend differently in relation to the current bid and ask prices, the differential between them, or volume of trades in the stock; or one which spots something changing in one parameter and then selects an analytical path through available tools to determine the significance, or lack thereof, of the noted change. Thus, there is no context-sensitive selection of analytical tools or sequence through those tools. The average investor, therefore, may fail to select the right tools and easily may reach incorrect conclusions, and make decisions, without considering important information, and so forth.

### SUMMARY OF THE INVENTION

The present invention addresses this situation and, in particular, the need for a tool (i.e., a system and method) that helps a user find a useful path through the available information on a stock or other quantity or entity, to facilitate the formation of conclusions based on the relevant information. To maximize availability of the tool, it may be provided within one or more sites on the global Internet, particularly its World Wide Web component, or on other networks or sites, such as intranets and extranets.

The invention thus has several aspects. According to a first aspect, the invention involves a server computer in a computer system typically having a server computer which delivers up web pages with which a user, operating a client computer, interacts via a communications channel to obtain a domain-specific analysis of a selected domain-specific parameter or tool. A suitable communications channel is, without limitation, the global Internet, though other networks also may be used. The “domain” may be publicly traded securities, company financial performance, sports team or individual athlete performance or other realms in which a performance over time or in relationship to others will be of interest. Obviously, the metrics for a sports team will be different from the metrics for a company, so the parameters to be calculated and analyzed are specific to the selected domain. The client computer may, for example, be a typical personal computer employing a commercial operating system and browser software for pulling down web pages from the server computer. The server computer or one or more computers in communication with the server computer (collectively referenced to as the “server computer”) executes appropriate software (i.e., computer programs) to pull information from appropriate data sources, which may be local or remote to the server computer, and to analyze that data and present the analyses. These analyses typically are presented in a predetermined format, with selected text being dependent upon the results of the data analysis. In a second aspect, the invention involves a computer program product which provides instructions which, when executed on the server computer, causes the server computer to perform the appropriate operations to deliver to client computers the aforementioned web pages and information sought by the users of the client computers. In a third aspect, the invention involves a method for providing context-specific of real-time data on a value of a domain-specific inquiry, and commentary explaining the significance of that real-time data. Thus, the explanation of the significance of the value depends on the value. Preferably, one or more additional sources of information likely to be relevant to the user's inquiry also are suggested.

According to another aspect of the invention, there is provided apparatus for use in a client-server environment for assisting an individual to analyze a domain-specific parameter, comprising a server computer program instructions to (1) receive from the client computer an identification of a parameter to be analyzed, (2) obtain from a data source a current value for the parameter, and (3) provide to the user computer an evaluation of the current value and an explanation of a possible significance of that evaluation. Providing an evaluation of the current value optionally includes dividing into broad bands a range the parameter values have experienced over a predetermined period of time, and relating the current value in terms of said bands. Providing an evaluation may further include providing a possible or likely significance of the value falling within a specific band. The server computer also may execute program code to provide a reference to one or more additional tools or parameters that might beneficially be studied next. The parameter may be a performance characteristic of a publicly traded security.

In another aspect, the invention is a computer program product comprising a computer-readable medium having encoded therein computer program instructions for execution by a server computer for assisting an individual at a client computer, in communication with the server computer, to analyze a domain-specific parameter, said computer program instructions comprising instructions which, when executed, cause the server computer to (1) receive from the client computer an identification of a parameter to be analyzed, (2) obtain from a data source a current value for the parameter, (3) provide to the client computer an evaluation of the current value and an explanation of a possible significance of that evaluation. The computer program product may include instructions which cause the server computer to provide an evaluation of the current value include instructions dividing into broad bands a range the parameter values have experienced over a predetermined period of time, and relating the current value in terms of said bands. The instructions causing the server computer to provide an evaluation may further include instructions which when executed cause the server computer to provide a possible or likely significance of the value falling within a specific band. The computer program product also may include instructions which when executed by the server computer provide a reference to one or more additional tools or parameters that might beneficially be studied next. The parameter may be a performance characteristic of a publicly traded security.

One further aspect of the invention is a method for assisting an individual to analyze a domain-specific parameter, such as a performance characteristic of a publicly traded security. The method comprises providing a server computer; providing a client computer in communication with the server computer; and operating the server computer to execute computer program instructions to (1) receive from the client computer an identification of a parameter to be analyzed, (2) obtain from a data source a current value for the parameter, and (3) provide to the user computer an evaluation of the current value and an explanation of a possible significance of that evaluation. Operating the server computer to provide an evaluation of the current value may include executing program instructions to divide into broad bands a range the parameter values have experienced over a predetermined period of time, and relating the current value in terms of said bands. The method may further include operating the server computer to execute instructions providing a possible or likely significance of the value falling within a specific band. The server computer may execute program instructions to provide a reference to one or more additional tools or parameters that might beneficially be studied next.

### BRIEF DESCRIPTION OF THE DRAWINGS

The foregoing and other features and advantages of the present invention will become more fully understood and appreciated from the detailed description below, which should be read in conjunction with the accompanying drawings, wherein like numerals refer to like elements.

In the drawings:

FIG. 1 is a diagrammatic illustration of a system in which the invention may be provided;

FIG. 2 is a pictorial illustration of an exemplary web page that a user might encounter when going to a web page for information on stock performance;

FIG. 3 is a pictorial illustration of an exemplary web page to which a user might be directed from the page of FIG. 2, upon selecting to analyze the current price-to-earnings ration for a stock; and

FIG. 4 is a diagrammatic illustration of an exemplary window that might be provided to the user when the user selects the Active Coach button from the web page of FIG. 3.

### DETAILED DESCRIPTION

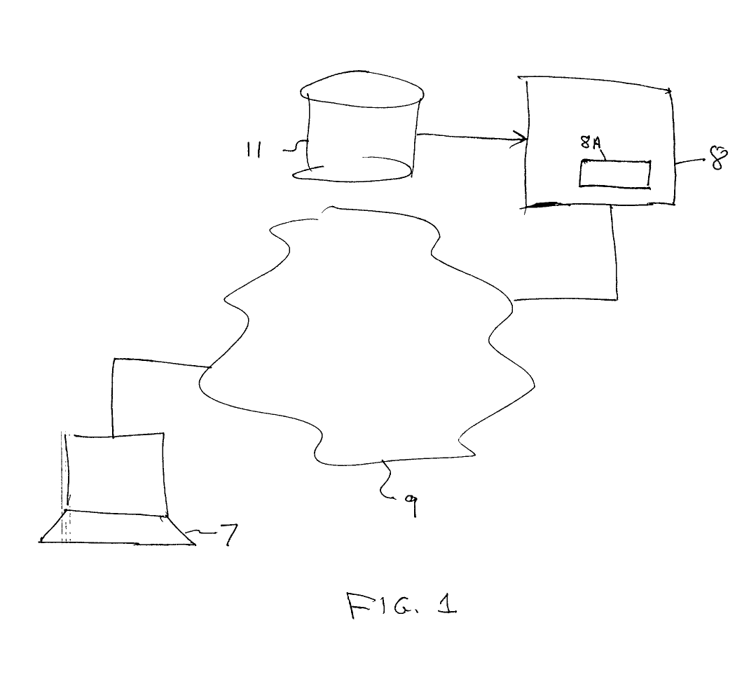

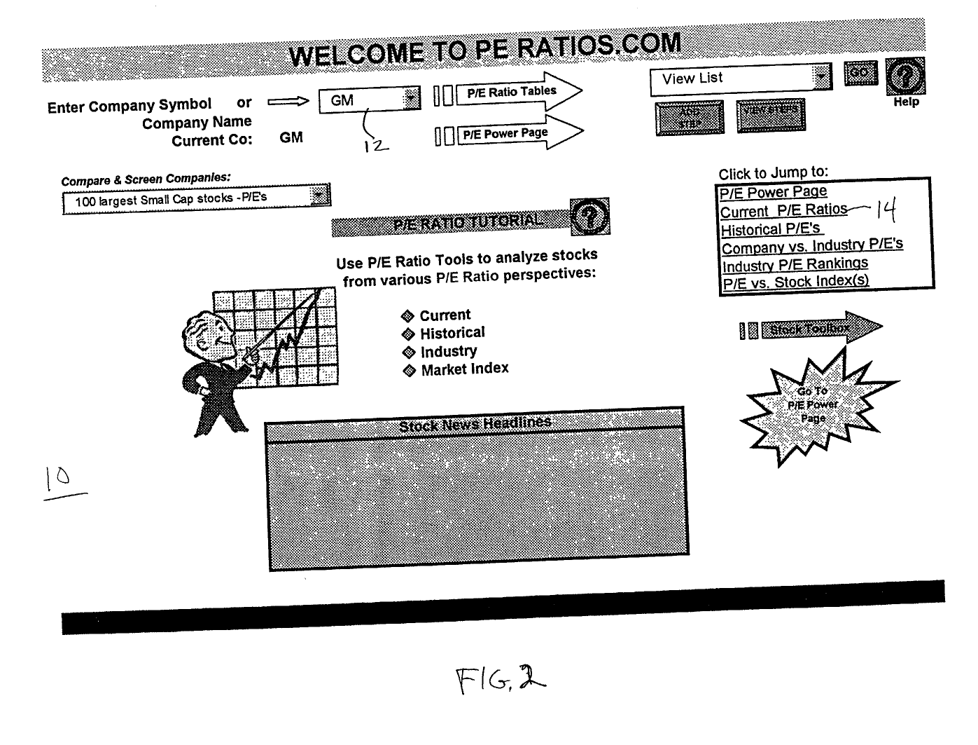

An exemplary system for providing data analysis and interpretation as taught herein is illustrated in FIGS. 1-4. Starting at FIGS. 1 and 2, taken together, there is shown a typical web page 10 which may be provided as a user interface to a user (client) computer 7 by a server computer 8 at a site on a network 9, such as the World Wide Web. This particular exemplary page 10 is devoted to presentation and analysis of the price-to-earnings ratio (P/E) for a selected stock. The stock symbol or company name is entered by the user at input box 12.

In response to user entry of the stock symbol or company name, the server computer 8 pulls from a database 11 relevant data relating to the indicated security. Database 11 may be local or remote to the server computer and may be populated in any convenient way, such as by data fed from one or more sources of financial information (not shown), including various commercial financial news services.

For purposes of this explanation, it shall be assumed the database contains appropriate data for the selected security or information domain of interest, without regard to how the data was obtained, as that is not part of the invention.

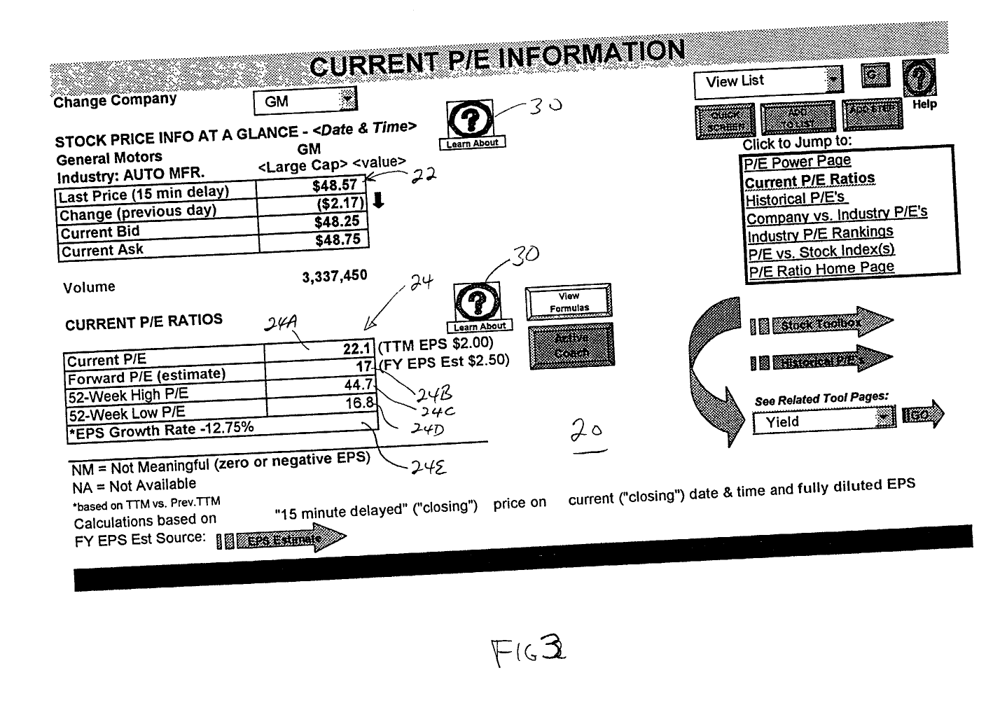

For the sake of having an example to clarify the utility of the invention, assume that the user has input the symbol “GM,” which denotes the common stock of General Motors Corporation. Software tools (e.g., on the server computer) may be accessed from this page 10 to analyze the P/E of GM stock from a number of different perspectives, such as: (1) the current value, (2) historical performance of the P/E, (3) performance of the P/E relative to the relevant industry sector, and (4) performance relative to market indices. Clicking on Current P/E Information, 14, causes the server to generate a new page 20, as shown in FIG. 3. This new page contains information on the then current price of GM stock, at 22, and information on the current P/E of GM stock, at 24. Actually, the page 20 is a form or report to provide data obtained from one or more databases or data sources (e.g., 11) which are commercially available. Those skilled in information retrieval and presentation will readily understand how to obtain and present the requested information. The current P/E information includes the current P/E, at 24A, a forward-looking estimate of P/E, at 24B, the 52-week high and low P/E values, 24C and 24D, respectively, and the earnings per share (EPS) growth rate 24E used to calculate the forward-looking P/E.

Clicking on the circled question mark icon 30 initiates a so-called Active Coach system, with a call to the server computer. By comparing the value of a current real-time tool (in this case, P/E) with the upper and lower ends of a range of similar values, the Active Coach system determines and presents analysis suggestions by the server. (Note that the term “tool” is used here to indicate a financial or securities analysis parameter or function.) The span between those upper and lower values in the range is divided into a number of sub-ranges. For example, there may be three subranges representing the upper twenty-five percent of values, the middle fifty percent of values and the lower twenty-five percent of values. In turn, each of these sub-ranges may be subdivided into multiple divisions representing, for example, upper, middle and lower sub-ranges. Of course, other ranges and subranges may be used.

As a function of the selected software tool, text may be displayed which “analyzes” the current value and offers suggestions for further analysis, either within the current site or on another site.

Narrow ranges can be evaluated by dividing the bottom of the range by the top of the range. Values near plus or minus one are considered to reflect a narrow range. Securities that trade in very narrow ranges may require special analysis.

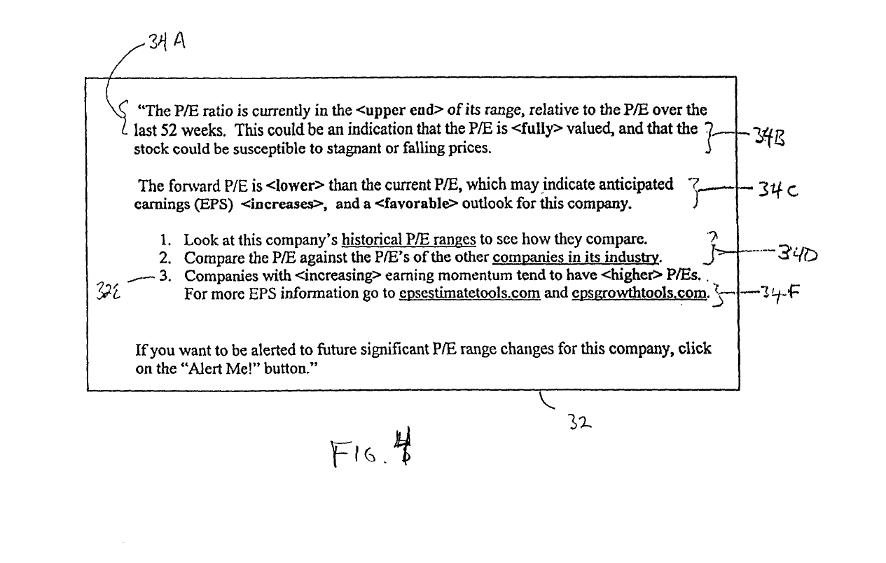

As an example, the “current” P/E table 24 indicates that GM's current P/E is 18.7 and its P/E ratio for the previous 52 weeks has ranged between a high of 20 and low of 10. When the user clicks the button 30, a text window appears, as at 32 in FIG. 4. The text in window 32 first reports the analysis at 34A, that the current P/E is in the upper, middle or lower end of its range for the last 52 weeks. In this instance, the P/E for GM stock is currently in the upper end of that range. Next, a sentence or two is provided (at 34B) to explain the significance of that analysis. In the example, the sentence warns that the P/E may be fully valued, meaning that, as a consequence, the stock price might be expected to be stagnant or to fall.

The next paragraph, 34C, presents the results of an analysis of a quantity known as forward P/E, and an interpretation of that analysis. Here, in the present example, the paragraph explains that the forward P/E is lower than the current P/E and interprets this situation as possibly indicating anticipated EPS increases and a favorable outlook. Thus, if only the P/E had been considered, the user would have reached one conclusion; if only the forward P/E had been considered, quite a different conclusion would have been reached. Of course, in light of securities laws in the U.S., it may not be advisable to make forward-looking projections and this is only optional.

Window 32 next presents (at 34D) recommendations for steps the user may wish to take to make a more complete analysis of the selected “tool”, which is this case is P/E. In the example, this includes examining the company's historical P/E ranges and comparing the company's P/E's to those of other companies in its industry (or business sector or region or other grouping). A brief wrap-up analysis may be presented, as well, as at 34E, and recommendations to links for further information may be offered. In this instance, those recommendations are for links to more EPS information, at 34F.

While an example has been given relative to P/E, it should be apparent that the same system and method are applicable to using tools that analyze a company's earnings, its revenues, stock yield (EPS), and so forth. The system and method of the invention are readily extended to include other types of information analysis and news comprehension coaching, as well, explaining how to read and understand data and news text, as well as suggesting follow-up research. For example, such coaching may be provided with respect to individual athlete or sports team performance, press release analysis, business news and general news within specific domains.

Conventional document assembly techniques may be employed to integrate the static text, data-dependent and context-dependent text with the data values. For each such information domain, a decision tree has to be developed to permit selection of the text strings to be selected for each potential data value or range of data values. Using a database of text strings, the appropriate data values, associated calculations and the decision tree, the document assembly program will then generate the test presented in the coaching “box” or presentation.

In general, in response to a user selecting a domain-specific parameter or tool for analysis, the value of the tool is reported in a context that a typical user should understand. This context generally will include an expression of the value within a range of values the parameter or tool has occupied over a historical period of time. To formulate this expression, the range may be divided into a number of broad bands, and the value is then reported as falling within one of those bands. The possible or likely significance of a value falling within a specific band is then given. Preferably, a projected value for the parameter or tool also is presented and its possible or likely significance given. As well, references are then given to additional information to be analyzed, including suggestions of one or more additional tools or parameters that might beneficially be studied next.

It will be apparent that the word “tool,” when used herein, except when used in the expression “software tool”, generally is synonymous with a function or view for evaluating a parameter or a mathematical function of one or more parameters. For example, revenue is a basic parameter or characteristic of business functioning, but price-to-earnings ratio is a function of both share price and earnings (i.e., profits). Both revenue and P/E may be useful for evaluating a company's stock and it is helpful to use certain views, such as 52-week high and low span, and to generically collect them under an umbrella term, “tool.” All of the functionality described herein, including the implementation of tools, should be understood as preferably achieved with one or more suitable computer programs executing on one or more computers (typically, the server computer), though computer programs have not been explicitly illustrated. Such computer programs typically are stored on any of a variety of media, indicated at 8A in FIG. 1, including, for example, read-only memory, random access memory, magnetic storage, optical storage, and so forth. Such media may be internal or external to the aforesaid computers, or partly internal and partly external. The client computer also may execute one or more or part of any such programs, or the client computer may act merely as an access device running a web browser.

Having thus described the inventive concepts and a number of exemplary embodiments, it will be apparent to those skilled in the art that the invention may be implemented in various ways, and that modifications and improvements will readily occur to such persons. Thus, the examples given are not intended to be limiting. The invention is limited only as required by the following claims and equivalents thereto.

We claim:

1. Apparatus for assisting an individual using a client computer to analyze a domain-specific parameter, comprising: a server computer executing computer program instructions to
(1) receive from the client computer an identification of a parameter to be analyzed,
(2) obtain from a data source a current value for the parameter, and
(3) provide to the user computer an evaluation of the current value and an explanation of a possible significance of that evaluation.

2. The apparatus of claim 1, wherein providing an evaluation of the current value includes dividing into broad bands a range the parameter values have experienced over a predetermined period of time, and relating the current value in terms of said bands.

3. The apparatus of claim 2, wherein providing an evaluation further includes providing a possible or likely significance of the value falling within a specific band.

4. The apparatus of any of claims 1-3 further including the server computer executing program code to provide a reference to one or more additional tools or parameters that might beneficially be studied next.

5. The apparatus of claim 4 wherein the parameter is a performance characteristic of a publicly traded security.

6. A computer program product comprising a computer-readable medium having encoded therein computer program instructions for execution by a server computer for assisting an individual at a client computer to analyze a domain-specific parameter, said computer program instructions comprising instructions which, when executed, cause the server computer to
(1) receive from the client computer an identification of a parameter to be analyzed,
(2) obtain from a data source a current value for the parameter,
(3) provide to the client computer an evaluation of the current value and an explanation of a possible significance of that evaluation.

7. The computer program product of claim 6, wherein the instructions which cause the server computer to provide an evaluation of the current value include instructions dividing into broad bands a range the parameter values have experienced over a predetermined period of time, and relating the current value in terms of said bands.

8. The computer program product of claim 7, wherein the instructions causing the server computer to provide an evaluation further include instructions which when executed cause the server computer to provide a possible or likely significance of the value falling within a specific band.

9. The computer program product of any of claims 6-8 further including instructions which when executed by the server computer provide a reference to one or more additional tools or parameters that might beneficially be studied next.

10. The computer program product of claim 9 wherein the parameter is a performance characteristic of a publicly traded security.

11. A method for assisting an individual to analyze a domain-specific parameter, comprising:
a. providing a server computer;
b. providing a client computer in communication with the server computer; and
c. operating the server computer to execute computer program instructions to
(1) receive from the client computer an identification of a parameter to be analyzed,
(2) obtain from a data source a current value for the parameter, and
(3) provide to the user computer an evaluation of the current value and an explanation of a possible significance of that evaluation.

12. The method of claim 1, wherein operating the server computer to provide an evaluation of the current value includes executing program instructions to divide into broad bands a range the parameter values have experienced over a predetermined period of time, and relating the current value in terms of said bands.

13. The method of claim 12, wherein operating the server computer to provide an evaluation further includes operating the server computer to execute instructions providing a possible or likely significance of the value falling within a specific band.

14. The method of any of claims 11-13 further including the server computer executing program instructions to provide a reference to one or more additional tools or parameters that might beneficially be studied next.

15. The method of claim 14 wherein the parameter is a performance characteristic of a publicly traded security.
